(19) United States
(12) Patent Application Publication
(10) Pub. No.: US 2008/0319109 A1
(43) Pub. Date: Dec. 25, 2008

(54) Solid Pigment Preparations Containing Resin

(75) Inventors: Ruth Bauer, Mannheim (DE); Oliver Seeger, Mannheim (DE); Kirill Bramnik, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/097,555

(22) PCT Filed: Dec. 21, 2006
(86) PCT No.: PCT/EP2006/070077

§ 371 Date: Jun. 16, 2008

(30) Foreign Application Priority Data
Jan. 5, 2006 (DE) 10 2006 000 997.5

(51) Int. Cl. C09B 67/22

(52) U.S. Cl. 524/89; 524/592; 524/94; 524/190; 524/92; 524/593

(57) ABSTRACT

Solid pigment preparations comprising as essential components
(A) 80 to 99.5% by weight of a pigment component comprising at least one organic pigment (A1) and one inorganic pigment (A2) and
(B) 0.5 to 20% by weight of at least one water-soluble/water-dilutable aldehyde resin or ketone resin.

The present invention relates to solid pigment preparations comprising as essential components
(A) 80 to 99.5% by weight of a pigment component comprising at least one organic pigment (A1) and one inorganic pigment (A2) and
(B) 0.5 to 20% by weight of at least one water-soluble/water-dilutable aldehyde resin or ketone resin.

The invention also relates to a process for preparing these pigment preparations and to their use for coloring paints, printing inks, plastics, building materials, and decorative cosmetic preparations.

Pigment preparations comprising both organic and inorganic pigment have been of particular interest for a relatively long time, since they afford the possibility of combining the advantages of organic pigments (high color strength, high cleanness of hue) with those of inorganic pigments (good opacity, high gloss).

They are generally prepared by grinding a mixture of organic and inorganic pigment. As well as dry grinding methods the patent literature also describes, in particular, wet grinding methods.

For instance, U.S. Pat. No. 4,226,634 discloses pigment preparations which are based on rutile mixed phase pigments and organic pigments and are prepared by wet-grinding the pigments with glass beads under the action of shearing forces. The predominantly aqueous millbase suspensions comprise no further auxiliaries.

EP-A-985 712 describes granular pigment preparations which are based on bismuth vanadate or rutile mixed phase pigments and organic pigments, especially C.I. Pigment Yellow 138 and 139, and are obtained by aqueous grinding of organic and inorganic pigment with glass beads and subsequent spray drying. It is mentioned that in the course of grinding it is possible to add up to 2% by weight of dispersing assistant, relative to the pigments, but no such addition is made in the examples.

WO-A-2004/78852 describes pigment preparations based on rutile mixed phase pigments and organic red and yellow pigments that are prepared by aqueous wet grinding of the pigments in the presence of 1% to 2% by weight, relative to the pigments, of a surface-active substance in the form of a macromolecular organic compound. The surface-active substance there is said to be an organically modified polyacrylate, a modified fatty acid derivative, a block copolymer having surface-active functions, or an alkylammonium salt of polyfunctional polymers.

Finally EP-A-1 277 808 discloses pigment preparations comprising organic or inorganic pigment and a urea/aldehyde resin. These pigment preparations, however, are prepared not by grinding but instead by extrusion of a mixture of pigment and resin, and comprise at least 20% by weight of resin.

It was an object of the invention to provide pigment preparations based on organic and inorganic pigments that are notable for advantageous performance properties, in particular a homogeneous commixing of organic and inorganic pigment.

We have found, accordingly, pulverulent pigment preparations comprising as essential components
(A) 80 to 99.5% by weight of a pigment component comprising at least one organic pigment (A1) and one inorganic pigment (A2) and
(B) 0.5 to 20% by weight of at least one water-soluble/water-dilutable aldehyde resin or ketone resin.

Additionally we have found a process for preparing these pigment preparations which comprises subjecting the organic pigment (A1) and the inorganic pigment (A2) to comminution in an aqueous medium in the presence of the resin (B).

We have also found the use of the pigment preparations for coloring paints, printing inks, plastics, building materials, and decorative cosmetic preparations.

The pigment preparations of the invention are distinguished by particularly homogeneous commixing of organic and inorganic pigment, which also leads to advantageous, homogeneous incorporability of the pigment preparations in all application media. Surprisingly, despite dilution with the resin (B), the pigment preparations exhibit a color strength which is situated at least at the same high level as the color strength of the preparations described in earlier German patent application 10 2004 040 670.7 and prepared by intensive dry mixing of the pigments.

The pigment preparations of the invention are not subject to any restriction with regard to the selection of the organic pigment (A1) and of the inorganic pigment (A2).

Particular importance is possessed by the pigment preparations of the invention as a substitute for lead chromate and lead molybdate pigments for the red-orange-yellow hue range.

Correspondingly the organic pigment (A1) present in the pigment preparations of the invention is preferably a pigment from the series of pyrazolonequinazolone pigments, isoindoline pigments, azo pigments, diketopyrrolopyrrole pigments or quinophthalone pigments, or combinations of these pigments.

Examples of particularly suitable pigments (A1) from these pigment classes are
pyrazolonequinazolone pigments:
   C.I. Pigment Orange 67 and C.I. Pigment Red 216;
isoindoline pigments:
   C.I. Pigment Yellow 139 and 185;
   C.I. Pigment Orange 61 and 69;
   C.I. Pigment Red 260;
azo pigments:
   C.I. Pigment Yellow 2, 13, 62, 74, 151, 168 and 191;
   C.I. Pigment Orange 5, 13, 34, 36, 64 and 67;
   C.I. Pigment Red 1, 2, 3, 4, 5, 23, 48:1, 48:2, 48:3, 48:4, 49, 49:1, 51:1, 53, 53:1, 57:1, 58:2, 58:4, 112, 144, 146, 148, 166, 170, 184, 214, 220, 221 and 251;
diketopyrrolopyrrole pigments:
   C.I. Pigment Orange 71 and 73;
   C.I. Pigment Red 254, 264 and 272;
quinophthalone pigments:
   C.I. Pigment Yellow 138.

Particular preference is given here to C.I. Pigment Orange 67, C.I. Pigment Yellow 139, C.I. Pigment Red 170, and C.I. Pigment Red 254, and also to combinations of C.I. Pigment Orange 67 with at least one of these pigments.

As inorganic pigment (A2) as well it is possible in principle to use any inorganic pigment or a combination of inorganic pigments. Particular importance is possessed in turn by inorganic pigments in the brown and yellow hue range. Preferred inorganic pigments (A2) therefore come from the series of the rutile mixed phase pigments and bismuth vanadate pigments.

In this context it is possible to employ all known pigments. Examples that may be mentioned of rutile mixed phase pigments include rutile pigments doped with coloring ions of the metals nickel, chromium, manganese, iron and/or niobium. Suitable bismuth vanadate pigments may be in the tetragonal crystal polymorph or in the preferred monoclinic crystal polymorph, and may be in any known doping form.

Examples of particularly suitable pigments (A2) are as follows: C.I. Pigment Brown 24, 29, 37 and 40 and C.I. Pigment Yellow 53, 157, 159, 160, 161, 162, 163, 164 and 189 and also C.I. Pigment Yellow 184. Preference is given here in particular to C.I. Pigment Brown 24 and, alongside it, also to C.I. Pigment Yellow 42 and 184.

The pigment preparations of the invention comprise as a further component (B) a water-soluble/water-dilutable aldehyde resin or ketone resin.

Aldehyde resins and ketone resins are the polycondensation products of aldehydes and/or ketones, which may comprise urea as a further condensation component. In this context use is conventionally made, as aldehyde component, of aliphatic aldehydes, especially formaldehyde, but also isobutyraldehyde, and, as ketone component, of cycloaliphatic ketones, especially cyclohexanone and its derivatives, such methyl- and tert-butylcyclohexanone, or araliphatic ketones, such as acetophenone. In lieu of urea itself use is also made of substituted ureas and cyclized derivatives, such as 2-imidazolidinone.

The aldehyde resins and ketone resins are not themselves water-soluble/water-dilutable, but can be converted into water-soluble/water-dilutable products by means of modification.

One possibility of modification lies in the reaction with polymers containing acid groups, examples being polyesters, dimerized or oligomerized unsaturated aliphatic carboxylic acids and/or addition polymers, containing acid groups, of olefinically unsaturated monomers, at elevated temperature (preferably in the melt at 100 to 220° C.), with subsequent neutralization of the reaction product. Modified aldehyde resins and ketone resins of this kind are described for example in EP-A-908 486.

Preference is given to aldehyde resins and ketone resins which have been modified with alkyd resins. Alkyd resins are the condensation products of polyesters formed from polyhydric alcohols and polybasic carboxylic acids (anhydrides) with fatty acids, synthetic monocarboxylic acids or fatty oils.

Typical examples of the constituents of the alkyl resins include the following: alcohol components, such as glycerol, pentaerythritol, trimethylolethane, trimethylolpropane, and diols such as ethylene glycol and/or propylene glycol, diethylene glycol, and neopentyl glycol; carboxylic acids (anhydrides), such as phthalic acid (anhydride), isophthalic and terephthalic acid, trimellitic anhydride, adipic acid, azelaic acid, and sebacic acid; oils and/or fatty acids/monocarboxylic acids, such as drying oils, e.g., linseed oil, oiticica oil, and tung oil; semidrying oils, e.g., soybean oil, sunflower oil, safflower oil, ricinene oil, and tall oil; non-drying oils, e.g., castor oil, coconut oil, and peanut oil; free fatty acids of these oils, and synthetic monocarboxylic acids.

A further possibility for modification of the aldehyde resins and ketone resins lies in the reaction of isocyanates.

Modified aldehyde resins and ketone resins are available commercially under the names, for example, of Laropals (BASF) and Kunstharz or Synthetic Resin (Degussa).

The pigment preparations of the invention comprise 80% to 99.5% by weight, in particular 85% to 98% by weight, of pigment component (A), comprising at least one organic pigment (A1) and at least one inorganic pigment (A2), and 0.5 to 20% by weight, especially 2% to 15% by weight, of water-soluble/water-dilutable aldehyde resin or ketone resin (B).

Pigment component (A) comprises generally 20% to 99% by weight of the organic pigment (A1) and 1% to 80% by weight of inorganic pigment (A2), preferably 30% to 70% by weight of organic pigment (A1) and preferably 30% to 70% by weight of inorganic pigment (A2).

The pigment preparations of the invention are obtainable advantageously by the preparation process likewise in accordance with the invention, which involves subjecting organic pigment (A1) and an inorganic pigment (A2) to comminution in an aqueous medium in the presence of the resin (B) and subsequently subjecting the resultant pigment preparation to conventional isolation and drying.

The effect of the resin (B) here is to bring about uniform wetting not only of the predominantly hydrophilic inorganic pigments (A2) but also of the predominantly hydrophobic organic pigments (A1) with the aqueous medium, so that there is a homogeneous mixing of the pigments in the comminuting operation.

For the process of the invention it is possible to employ not only crude, as synthesized pigments but also pigments which have already undergone a pigment finish, i.e., an adjustment of particle morphology and particle size.

Comminution is performed in accordance with the invention in an aqueous medium. The liquid phase used in the operation is preferably water alone, though it is also possible to use mixtures of water with water-miscible organic solvents, alcohols for example. Conventionally the pigment content of the aqueous suspension is 5% to 40% by weight.

Comminution can be carried out in a high-speed stirring disk apparatus, a dissolver. Division here is brought about by shearing fields close to the stirrer disk, which is provided on its edge with impact devices, and also by the pressure switch which comes about in the dispersion material between closely adjacent zones of high pressure and underpressure.

Comminution may also take place by conventional wet grinding in a ball mill, with or without stirring, which is operated preferably at 100 to 2000 rpm. Examples of suitable grinding media include glass beads, zirconium oxide beads, and sand grains with a diameter of approximately 0.4 to 30 mm.

Dispersion or grinding is conventionally continued until the average particle size of the inorganic pigment (A2) is approximately 0.4 to 2 μm.

The pigment suspension obtained can be dried—after separation from the grinding media in the case of grinding—advantageously in a spray drying unit, the pigment preparations of the invention being obtained in the form of dustlike granules. Suitable assemblies include, for example, a spraying tower or fluidized spraying bed, in which the water is evaporated with gasification using hot gas, such as air or nitrogen. Through a controlled selection of the drying conditions it is possible to control the size of the granules.

The pigment suspension can of course also be dried in a conventional dryer, such as a paddle drier. In this case the material for drying may be subjected if desired to a simultaneous or subsequent deagglomeration operation, in order to destroy the agglomerates which form in the course of drying. In this case, pulverulent pigment preparations are obtained.

The pigment preparations of the invention are outstandingly suitable for coloring paints and printing inks, including in particular water-based paints and printing inks, and also for coloring plastics, building materials, and decorative cosmetic preparations. In these applications they are distinguished by their advantageous coloristic properties, in particular their high color strength, and their homogeneity.

### EXAMPLES

### Preparation and Assessment of Inventive Pigment Preparations

The pigment preparations were prepared as described below. The amounts reported for the respective resin (B) are based on the dissolved resin itself. As resin (B) use was made of the following:
(B1): aqueous solution of alkyd resin-modified aldehyde resin Laropal® LR 9008 (solids content: 35%; pH: 8)
(B2): aqueous solution of alkyd resin-modified aldehyde resin Laropal LR 8991 (solids content: 35%; pH: 8)

Each of the aqueous pigment suspensions prepared exhibited homogeneous commixing and no phase segregation at all. In contrast, pigment suspensions comprising no resin (B) exhibited a separation of hydrophobic organic pigment and inorganic pigment.

In an alkyd-melamine baking varnish the inventive pigment preparations exhibited a color strength at least at the same level as the color strength of pigment preparations obtained by dry grinding without additives, in accordance with earlier German patent application 10 2004 040 670.7.

### Example 1

A mixture of 28.4 parts by weight of C.I. Pigment Orange 67, 9 parts by weight of C.I. Pigment Yellow 139, 52.6 parts by weight of C.I. Pigment Brown 24, 10 parts by weight of resin (B1), and 360 parts by weight of water was ground in a Dispermat® N1 dissolver (VMA) for 2 minutes and then dried in a drying cabinet at 110° C.

### Example 2

A mixture of 28.4 parts by weight of C.I. Pigment Orange 67, 9 parts by weight of C.I. Pigment Yellow 139, 52.6 parts by weight of C.I. Pigment Brown 24, 10 parts by weight of resin (B2) and 360 parts by weight of water was ground in a Dispermat N1 dissolver (VMA) for 2 minutes and then dried in a drying cabinet at 110° C.

### Example 3

A mixture of 29.9 parts by weight of C.I. Pigment Orange 67, 9.5 parts by weight of C.I. Pigment Yellow 139, 55.6 parts by weight of C.I. Pigment Brown 24, 5 parts by weight of resin (B1) and 380 parts by weight of water was ground in a Dispermat N1 dissolver (VMA) for 2 minutes and then dried in a drying cabinet at 110° C.

### Example 4

A mixture of 29.9 parts by weight of C.I. Pigment Orange 67, 9.5 parts by weight of C.I. Pigment Yellow 139, 55.6 parts by weight of C.I. Pigment Brown 24, 5 parts by weight of resin (B1) and 380 parts by weight of water was ground in a Molinex N1 bead mill (Netzsch) for 2 minutes and then dried in a drying cabinet at 110° C.

### Example 5

A mixture of 29.9 parts by weight of C.I. Pigment Red 254, 9.5 parts by weight of C.I. Pigment Yellow 139, 55.6 parts by weight of C.I. Pigment Brown 24, 5 parts by weight of resin (B1) and 380 parts by weight of water was ground in a Dispermat N1 dissolver (VMA) for 2 minutes and then dried in a drying cabinet at 110° C.

### Example 6

A mixture of 29.9 parts by weight of C.I. Pigment Red 170, 9.5 parts by weight of C.I. Pigment Yellow 139, 55.6 parts by weight of C.I. Pigment Brown 24, 5 parts by weight of resin (B1) and 380 parts by weight of water was ground in a Dispermat N1 dissolver (VMA) for 2 minutes and then dried in a drying cabinet at 111° C.

1. A solid pigment preparation comprising as essential components
(A) 80 to 99.5% by weight of a pigment component comprising at least one organic pigment (A1) and one inorganic pigment (A2) and
(B) 0.5 to 20% by weight of at least one water-soluble/water-dilutable aldehyde resin or ketone resin.

2. The pigment preparation according to claim 1, wherein the pigment component (A) comprises 20% to 99% by weight of the organic pigment (A1) and 1% to 80% by weight of the inorganic pigment (A2).

3. The pigment preparation according to claim 1, comprising as component (A1) at least one organic pigment from the group of pyrazoloquinazolone pigments, isoindoline pigments, azo pigments, diketopyrrolopyrrole pigments, and quinophthalone pigments.

4. The pigment preparation according to claim 1, comprising as component (A1) at least one pyrazolonequinazolone pigment.

5. The pigment preparation according to claim 1, comprising as component (A2) at least one inorganic pigment from the group of rutile mixed phase pigments and bismuth vanadate pigments.

6. The pigment preparation according to claim 1, comprising as component (B) at least one aldehyde resin or ketone resin which has been modified with an alkyd resin or with isocyanates.

7. A process for preparing a pigment preparation according to claim 1, which comprises subjecting the organic pigment (A1) and the inorganic pigment (A2) to comminution in an aqueous medium in the presence of the resin (B) and subsequently subjecting the resultant pigment preparation to conventional isolation and drying.

8. The process according to claim 7, wherein comminution is carried out using a stirred or unstirred ball mill or a dissolver.

9. A method of coloring paints, printing inks, plastics, building materials, and decorative cosmetic preparations comprising the use of the pigment preparation according to claim 1.
